(19) United States
(12) Patent Application Publication
(10) Pub. No.: US 2019/0381428 A1
(43) Pub. Date: Dec. 19, 2019

(54) Selective Polysaccharide Flocculants for Bauxite Ore Beneficiation

(71) Applicant: Kemira OYJ, Helsinki (FI)

(72) Inventors: Marcelo Moreira Da Costa, Ipantinga, MG (BR); Xihui Yin, Norcross, GA (US); Sergio Cabo, Sao Francisco (BR); Luis Irineu, Salvador BA (BR)

(21) Appl. No.: 16/480,547

(22) PCT Filed: Feb. 7, 2018
(86) PCT No.: PCT/US18/17261

§ 371 Date: Jul. 24, 2019

Related U.S. Application Data
(60) Provisional application No. 62/455,873, filed on Feb. 7, 2017.

(51) Int. Cl. B01D 21/01; C01F 7/02; C08B 37/14

(52) U.S. Cl. CPC B01D 21/01; C08B 37/143; C01F 7/02

(57) ABSTRACT

Selective flocculants for beneficiation of bauxite ore comprise one or more types of polysaccharides comprising one or more types of pentosan units. Also disclosed are processes for enriching aluminum hydroxide and alumina from bauxite ore comprising the aluminum hydroxide and alumina and clay materials and and/or siliceous gangue, wherein the process comprises carrying out a selective flocculation process in the presence of one or more of the selective flocculants.

### CROSS-REFERENCE TO RELATED APPLICATION

This application claims priority to U.S. Provisional Application No. 62/455,873, filed Feb. 7, 2017.

### FIELD OF THE ART

The present invention relates to selective flocculants for the beneficiation of bauxite ores.

### BACKGROUND

Bauxite ore is naturally occurring, heterogeneous material which is composed primarily of one or more aluminum hydroxide minerals and gangue minerals, such as quartz, iron oxide, titania, aluminosilicates (clays). Aluminum hydroxide minerals found in bauxites are typically gibbsite Al(OH)₃, boehmite γ-AlO(OH) and diaspore α-AlO(OH). Globally, most of the bauxite obtained is used as feed for the manufacturing of alumina (Al₂O₃) via a wet chemical caustic leach methods commonly known as the Bayer process. Subsequently, the majority of the resulting alumina produced from the refining process is in turn employed as the feedstock for the production of aluminum metal by the electrolytic reduction of alumina in a molten bath of natural or synthetic cryolite (Na₃AlF₆), which is known as the Hall-Héroult process.

Generally, the Bayer process includes the key steps of dissolution of alumina-rich minerals into hot caustic solution, separation of the insoluble phases, followed by gibbsite precipitation and calcination of the gibbsite to alumina (Misra, C., Industrial Alumina Chemicals ACS, Monograph 184; 1986, Amer Chem Soc, Washington, p. 8-53.) Usually, bauxite is first crushed and ground in caustic solution at about 60° C. Silicate minerals, such as kaolinite, in contact with the caustic solution, form Na₂SiO₃, NaAl(OH)₄ and water. Consequently, the silicate anions present in solution generate Bayer sodalite scale, in accordance with Equation 1 (below). Sodalite also contains other inorganic species, most commonly sulphate, carbonate, chloride, aluminate and hydroxide (represented as X in Eqaution 1).

6Na₂SiO₃+6NaAl(OH)₄+Na₂X→Na₆[Al₆Si₆O₂₄].Na₂X+12NaOH+6H₂O (Eqn. 1)

Slurry storage typically transforms 80-90% of the reactive silica into Sodalite, with the remainder being converted in digestion. Digestion conditions are tailored to the aluminous phase distribution of the bauxite, for example, if gibbsite is the only source of recoverable alumina, the digestion is performed at temperature of 140-155° C. Digestion times are often determined, not by the kinetics of gibbsite dissolution, but by the kinetics of residual sodalite formation, and more importantly, the reduction of the soluble silica in solution. In addition, reaction time in digestion is not determined by alumina dissolution kinetics, but kept to a minimum to avoid excessive dissolution of quartz, which provides reactive silica. Usually sodalite is discarded with the red mud residue, contributing to the loss of sodium hydroxide from the liquor (as least 1 mole NaOH per mole of reactive silica). This loss of sodium hydroxide from the liquor results in economical penalty and it is correlated with the reactive silicacontent of bauxite. Bauxites with reactive silica contents greater than ˜8% by weight are usually considered to be uneconomic to process. Therefore, improving the grade of the bauxite concentrate can be critical for efficient bauxite beneficiation.

The world bauxite resources are estimated at 55-75 billion tons in total (Bray, L., U.S. Geological Survey, Mineral Commodity Summaries, January 2012). This volume is defined as the bauxite for which economic extraction is potentially feasible. However, this estimate does not include non-identified reserves or lower grade bauxite deposits which are not considered to be economically feasible to extract with current bauxite beneficiation techonology (about 55-66% of the world's resources of bauxite). Such lower grade bauxite reserves typically contain high levels of reactive silica.

The processing of lower grade bauxite sources involves the removal of unwanted minerals (such as silicates and clays) which are an intrinsic part of the ore rock itself (gangue). In these beneficiation processes, the gangue is separated using techniques like crushing, grinding, milling, gravity or heavy media separation, screening, magnetic separation, and/or froth flotation to improve the concentration of the desired minerals and remove impurities. Development of new processes for bauxite beneficiation may offer opportunites for economically processing these low-quality ores.

In an effort to improve valuable mineral recovery, modified flotation systems have been employed, which involve a pre-conditioning of the mineral ores by dispersing the finely ground ore in an aqueous medium and initially subjecting it to a selective flocculation process. Following the selective flocculation stage, the system is deslimed to remove the gangue-bearing fines and the flocculated valuable mineral-containing residues are then concentrated to final grade by flotation and removal of the gangue material. In selective flocculation, the flocculants are added prior to the flotation and desliming stages and are selective in their flocculating properties so as to effectuate a separation between mineral species contained in the aqueous dispersion. In a bauxite ore system, the selective flocculant causes the flocculation of aluminum-containing particles while leaving the clays and siliceous materials in suspension.

### BRIEF SUMMARY

In view of the foregoing, one or more embodiments described herein include selective flocculants for beneficiation of bauxite ore comprising one or more types of polysaccharides comprising one or more types of pentosan units. Also described herein are compositions comprising the selective flocculants, as well as processes for enriching alumina, or available alumina, from bauxite ore comprising the alumina and clay materials and and/or siliceous gangue, wherein the process comprises carrying out a flocculation process in the presence of one or more selective flocculants according to the embodiments described herein.

The disclosure may be understood more readily by reference to the following detailed description of the various features of the disclosure and the examples included therein.

### DETAILED DESCRIPTION

According to the various embodiments described herein, selective flocculants may be used to improve the grade or recovery of aluminum hydroxide or alumina from aluminum-containing ore, such as bauxite ore. In particular, the selective flocculants may be used to improve the grade of available alumina in bauxite ore. The selective flocculants may be used for improving the economics and performance of, for example, the Bayer process of aluminum production. The exemplified selective flocculants are used in the processes described herein to selectively flocculate aluminum hydroxide or alumina from their associated clay mineral and siliceous gangue. In certain embodiments, the processes are effective for reducing the reactive SiO₂ and quartz content of bauxite ore.

By using the processes according to the embodiments, the aluminum grade of bauxite, or the amount of aluminum hydroxide or alumina produced from a portion of bauxite ore, may be enhanced. The processes may also be used to treat low grade bauxite ore or to recover valuable ore from tailings. Typically, low-grade bauxite ore responds poorly to conventional separation techniques, including gravity separation hydrocyclones, centrifuge, flotation or magnetic separation techniques. However, through the processes, it is become economically feasible to treat bauxite ore which contains about 10% to about 50%, or about 25% to about 40%, clay minerals and siliceous gangue.

As referred to herein “available alumina” in a sample of bauxite may be defined as that alumina which may be extracted at favorable digest conditions. Such conditions are not particularly limited and those of ordinary skill in the art will understand which conditions are favorable for digestion of alumina. In certain embodiments, the favorable digest conditions, include high caustic concentration (for example at least about 0.1 weight % of caustic compared to the weight of bauxite ore; or about 0.1 weight % to about 5 weight %, or 0.5 weight % to about 1.5 weight % caustic compared to the weight of bauxite ore. In certain embodiments, the favorable digest conditions, include high temperature (for example, about 100° C. to about 250° C., or about 150° C. to about 240° C.). In certain embodiments, the favorable digest conditions include both high caustic concentration and high temperatures.

In embodiments, the process comprises: (i) dispersing a ground ore in an aqueous medium, and (ii) adding an effective amount of one or more selective flocculants according to the embodiments to the aqueous medium containing the ground ore. In certain embodiments, the ground ore is finely ground ore, for example, the average particle size of the ground ore is less than about 1 mm, e.g., in the range between about 1 um and 1 mm.

In embodiments, the process may further comprise adding one or more additives selected from dispersants, surfactants, collecting agents and pH adjusting agents to the aqueous medium. In certain embodiments, the process further comprises adding one or more dispersants to the aqueous medium. In certain embodiments, the process further comprises adding one or more surfactants to the aqueous medium. In certain embodiments, the process further comprises adding one or more collecting agents, for example anionic collecting agents, to the aqueous medium. In certain embodiments, the process further comprises adding one or more pH adjusting agents, such as a base or acid, to the aqueous medium containing the ground ore. surfactants. In certain embodiments, the process further comprises adjusting the pH of the aqueous medium containing the ground ore with the addition of pH adjusting agents. In embodiments, other additives may be employed, or added to the aqueous stream, to adjust the process as necessary or desired, for example to increase the sedimentation rate.

In embodiments, the selective flocculant comprises one or more types of polysaccharides comprising one or more types of pentosan units.

In embodiments, the selective flocculants, compositions and processes may be used to provide improved grade or improved selectivity for the desired mineral, such aluminum hydroxides or alumina, compared to other flocculants such as starch or causticized starch. In particular, the selective flocculants may provide increased separation selectivity, decreased valuable ore fines loss, and/or decreased landfill.

Such advantages may be used to improve the grade of the aluminum, in particular the grade of the available alumina, in a concentrate to meet the requirement of a feedstock for an alumina manufacturing process, for example the Bayer process. In certain embodiments, the processes may be used to increase available alumina from low grade bauxite ore.

Definitions

As used herein, “bauxite” or “bauxite ore” refers to the aluminum-containing ore (or rock or deposit), which substantially comprises a mixture of hydrous aluminum oxides (alumina), aluminum hydroxides, clay minerals and other siliceous gangue, such as quartz; and other insoluble materials, such as iron oxides, for example, hematite, magnetite, and goethite; iron carbonates, for example siderite, and titanium dioxide. When processing bauxite ore to obtain aluminum, it is desirable to separate the desirable aluminum-containing compounds, such as alumina and aluminum hydroxide compounds, from the other materials in bauxite. The forms of aluminum hydroxide typically present in bauxite include: gibbsite Al(OH)₃, boehmite γ-AlO(OH), and diaspore α-AlO(OH). Through certain processes, such as the Bayer process, aluminum hydroxides may be obtained from bauxite and calcined to produce alumina (Al₂O₃), which is used as the feedstock for the production of aluminum metal.

As used herein, “gangue” or “siliceous gangue” refers to the undesirable minerals in a material, for example, a bauxite ore deposit that contains both gangue and the desired aluminum-containing compounds. Such undesirable minerals may include silica (e.g. quartz), clay minerals, titanium, sulfur and alkaline earth metals and the like. In embodiments, the gangue includes oxides of silica (e.g. SiO₂ or quartz), silicates or siliceous materials such as kaolinite, muscovite, smectite and the like.

As used herein “reactive silica” refers to dissolved silica that is slightly ionized and has not been polymerized into a long chain. In contrast, “unreactive silica” refers to polymerized or colloidal silica. Particulate silica compounds (e.g. clays, silts and sand) are usually 1 micron or larger and may be measured using the SDI test. Polymerized silica, which uses silicon dioxide as the building block, exists in nature (e.g. quartzes and agates). Silica, in the polymerized form, also results from exceeding the reactive silica saturation level. The solubility of reactive silica is typically limited to 200-300% with the use of a silica dispersant. Reactive silica solubility increases with increasing temperature, increases at a pH less than 7.0 or more than 7.8.

As used herein, “clay minerals” refers to hydrous aluminum silicates or hydrous magnesium silicates with a layer (sheetlike) structure and very small particle size. They may contain significant amounts of iron, alkali metals, or alkaline earths. Generally, clay minerals are composed essentially of silica, alumina or magnesia or both, and water, but iron substitutes for aluminum and magnesium in varying degrees, and appreciable quantities of potassium, sodium, and calcium are frequently present as well. Examples of clay minerals include, but are not limited to: 2SiO₂.Al₂O₃.2H₂O (kaolinite), 4SiO₂.Al₂O₃.H₂O (pyrophyllite), 4SiO₂.3MgO.H₂O (talc), and 3SiO₂.Al₂O₃.5FeO.4H₂O (chamosite). The SiO₂ ratio in a formula is the key factor determining clay mineral types. These minerals may be classified on the basis of variations of chemical composition and atomic structure into nine groups: (1) kaolin-serpentine (kaolinite, halloysite, lizardite, chrysotile), (2) pyrophyllite-talc, (3) mica (illite, glauconite, celadonite), (4) vermiculite, (5) smectite (montmorillonite, nontronite, saponite), (6) chlorite (sudoite, clinochlore, chamosite), (7) sepiolite-palygorskite, (8) interstratified clay minerals (e.g., rectorite, corrensite, tosudite), and (9) allophane-imogolite.

As used herein, a “pH adjuster”, “pH regulator” or “pH adjusting agent” refers to an agent that is used to change or control pH. Any suitable agent that is used to change or control pH may be used, including, for example, sodium hydroxide or ammonium hydroxide.

As used herein, a “flocculant” or “selective flocculant” refers to an agent that facilitates the agglomeration of particles in a suspension (such as a dispersed suspension). In embodiments, the selective flocculant is an agent that selectively enriches one fraction in, for example, alumina and/or aluminum hydroxide, while a second fraction is enriched in gangue. In embodiments, the flocculant facilitates enrichment of the underflow (UF) in alumina and/or aluminum hydroxide, and enrichment of the overflow (OF) in gangue. In embodiments, the increase in alumina in a fraction or in the underflow, is an increase in available alumina.

As used herein, the term “polysaccharide” refers to carbohydrate molecules of repeated monomer (monosaccharide) units joined together by glycosidic bonds. The polysaccharide may vary in structure, for example, may be linear or branched. The molecules may contain slight modifications of the repeating unit. Monosaccharides are generally aldehydes or ketones with two or more hydroxyl groups. A polysaccharide containing a single type of monosaccharide unit is referred to as a homopolysaccharide, while a polysaccharide containing more than one type of monosaccharide unit is referred to as a heteropolysaccharide. Polysaccharides are generally considered to contain ten or more monosaccharide units, while the term “oligosaccharide” is generally used to refer to the polymers containing a small number, e.g. two to ten, of monosaccharide units.

As used herein, “hemicellulose” refers to the heteropolymer polysaccharide components of plant cell walls other than cellulose. Hemicelluloses have sugars called pentoses such as xylose, each having five carbon atoms as constituent units, sugars called hexoses such as mannose, arabinose and galacturonic acid, each having six carbon atoms as constituent units, and optionally complex polysaccharides such as glucomannan and glucuronoxylan. Hemicellulose may be any of several heteropolymers present in almost all plant cell walls, e.g., xylan, arabinoxylan, glucuronoxylan, glucuronoarabinoxylan. Typically, the main chain (i.e., backbone) is composed of β-1,4-linked D-xylopyranose residues. Besides xylose, hemicelluloses may contain arabinose, glucuronic acid or its 4-O-methyl ether, and acetic, ferulic, and p-coumaric acids. In some cases, the monomers branch off the xylan backbone. The frequency and composition of branches are dependent on the source. All types of hemicellulose may be used in the embodiments.

As used herein, the term “starch” refers to a carbohydrate consisting of a large number of glucose units joined by glycosidic bonds. It is well established that starch polymer consists mainly of two fractions, amylose and amylopectin, which vary with the source of starch. The amylose having a low molecular weight contains one end group per 200-300 anhydroglucose units. Amylopectin is of higher molecular weight and consists of more, than 5,000 anhydroglucose units with one end group for every 20-30 glucose units. While amylose is a linear polymer having α 1→4 carbon linkage, amylopectin is a highly branched polymer with α 1→4 and α 1→6 carbon linkages at the branch points.

Selective Flocculants

In embodiments, the one or more selective flocculants may be selective in the flocculation of aqueous dispersions of metal ores, in particular, bauxite ores. In embodiments, the one or more selective flocculants do not substantially flocculate gangue materials, such as clay minerals and siliceous gangue. In embodiments, the amount of flocculation achieved is at least about 40%, about 45%, about 50%, about 55%, about 60%, about 65%, about 70%, about 75%, about 80%, about 85%, or about 90% of aluminum hydroxide and alumina, in the aqueous medium. In embodiments, the amount of flocculation achieved is in the range of about 40% to about 90%, about 40% to about 60%, or about 45% to about 55% aluminum hydroxide and alumina, in the aqueous medium. In embodiments, the amount of weight recovery achieved is at least about 40%, about 45%, about 50%, about 55%, about 60%, about 65%, about 70%, about 75%, about 80%, about 85%, or about 90% of aluminum hydroxide and alumina, in the aqueous medium. In embodiments, the amount of weight recovery achieved is in the range of about 40% to about 90%, about 40% to about 60%, or about 45% to about 55% aluminum hydroxide and alumina, in the aqueous medium. In certain embodiments, “alumina” refers to available alumina.

The embodiments include a selective flocculant having one or more types of polysaccharides comprising one or more types of pentosan units. pentosan units are monosaccharides having five carbon atoms, including, for example, xylose, ribose, arabinose, and lyxose. In embodiments, the pentosan unit may be an aldopentose, which has an aldehyde functional group at position 1, such as, for example, the D- or L-forms of arabinose, ribose, xylose and lyxose. polysaccharides include, for example, xylan, hemicellulose, and gum arabic.

hemicellulose is derived from lignocellulosic biomass, including, but not limited to: for example herbaceous crops, for example grasses, such as switch grass; wood, for example hardwood, such as pine wood, aspen wood and spruce wood; and agricultural residues, for example sugarcane bagasse, wheat straw, corn stover (which may include the stalk, leaves, husk and cob of the corn plant), corn fiber (corn bran or corn hull). In embodiments, the hemicellulose may contain mixtures of xylose, arabinose, mannose and galactose. Accordingly, any plant material comprising hemicellulose may be used in the prepare the selective flocculants. In certain embodiments, the one or more selective flocculants comprise hemicellulose. In certain embodiments, the one or more selective flocculants comprise polysaccharides are derived from one or more types of lignocellulosic biomass.

In some embodiments, gum arabic may contain arabinose and ribose. In embodiments, the one or more types of pentosan units comprises xylan units and one or more of hemicellulose and aldopentoses.

In a particular embodiment, the one or more selective flocculants are derived from a waste product of industrial processing. In certain embodiments, the one or more selective flocculants are derived from corn fiber, corn stover and mixtures thereof.

Corn fiber comprises a matrix of hemicellulose, cellulose, and lignin. Any corn fiber may be used in the present method, including native corn fiber and corn fiber produced by standard breeding techniques including crossbreeding, translocation, inversion, transformation or any other method of gene or chromosome engineering to include variations thereof. Native corn is intended to mean those varieties found in nature, including dent, waxy, or high amylose corn. In embodiments, the corn fiber may be obtained from a wet-milling or a dry-milling process. Accordingly, the corn fiber may be wet or dry. In embodiments, the corn fiber may be dried and stored prior to use in preparing the selective flocculants. The corn fiber may be de-starched corn-fiber. De-starched corn fiber is typically formed by liquefacation with α-amylase until at least part is soluble. Other methods of destarching known in the art are also suitable, including separation of the starch from the fiber, i.e., by a hydrocyclone, or by use of other enzyme(s) or combinations thereof

In embodiments, the one or more types of polysaccharides are derived from algae. In certain embodiments, the one or more types of polysaccharides are not derived from algae.

In embodiments, the selective flocculant may be a blend or a mixture of polysaccharides having one or more types of pentosan units. In certain embodiments, the selective flocculant may consist essentially of polysaccharides comprising one type of pentosan unit, for example xylan. In certain embodiments, the one or more types of pentosan units comprise xylan. In embodiments, a selective flocculant is provided that includes one or more types of polysaccharides comprising xylan units.

In embodiments, a polysaccharide comprising xylan may be extracted from plant material (e.g. lignocellulosic biomass) or from algae with dilute alkaline solutions, for example, as described in International Publication No. WO 2014/055502.

Xylan is an oligosaccharide which could be extracted in the form of 5 to 200 anhydroxylose units consisting of D-xylose units with 1β→4 linkages.

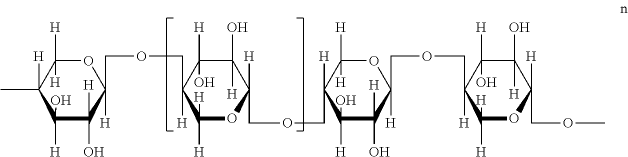

Xylan oligosaccharide with 5 to 200 anhydroxylose units consisting of D-xylose units with 1β→4 linkages

In embodiments, the polysaccharides comprising one or more types of pentosan unit may be extracted from the pulping black liquors, from the cold caustic extraction (CCE) filtrates, and/or from acid pre-hydrolyzes or auto-hydrolyzes process in order to achieve dissolve pulp grades. Such extractions are described in, for example, Jayapal et al. Industrial Crops and Products 2012, v. 42, pp. 14-24; Muguet et al. Holzforschung 2011, v. 65, pp. 605-612; and Gehmayer et al. Biomacromolecules 2012, v. 13, pp. 645-651.

In certain embodiments, the selective flocculants do not comprise substantial amounts of arabinose or ribose or sources thereof.

In embodiments, the selective flocculant may have any molecular weight so long as the selective flocculant has the effect of selectively flocculating the desired minerals in preference to flocculating the associated gangue. In embodiments, the molecular weight of the selective flocculant is about 50,000 to about 500,000 Daltons. In embodiments, the molecular weight of the selective flocculant is about 300 to about 3500 monocarbohydrate or aldopentose units, for example xylose units.

Compositions

In embodiments, a composition comprises one or more selective flocculants, as described herein, and a solvent. In embodiments, a composition comprises one or more selective flocculants and a solvent, wherein the one or more selective flocculants is one or more of the selective flocculants described herein. In embodiments, the solvent is water. In embodiments, the composition is a solution, for example, an aqueous solution.

In embodiments, the composition is a gel, for example a polysaccharide gel. In embodiments, the gel is water-soluble.

A composition according to the embodiments may be formulated to provide a sufficient amount of the one or more selective flocculants, i.e., an amount sufficient to produce a desired result.

In certainembodiments, the composition may further comprise one or more agents or modifiers known in the desliming art, such as dispersants. Examples of such agents or modifiers include, but are not limited to, sodium silicate and/or polyacrylic acid-based dispersants; sodium polyphosphate; surfactants, such as anionic surfactants; or another agent known in the art. Dispersants suitable for use in combination with the selective flocculants are not particularly limited and include: KemEcal™ TC2500 (a sodium silicate and polyacrylic acid dispersant available from Kemira Chemicals, Inc.), sodium polyphosphate and the like.

In embodiments, the composition may be used in a process wherein the one or more agents or modifiers known in the desliming art, such as dispersants, are added separately.

In embodiments, the composition includes one or more conventional selective flocculants or a flocculant which is not a selective flocculant according to the embodiments described herein. Other selective flocculants that may be used in combination with the flocculants include, but are not limited to: starch, such as tapioca, corn, potato, wheat, rice and the like; starch activated by treatment with alkali; cellulose esters, such as carboxymethylcellulose and sulphomethylcellulose; cellulose ethers, such as methyl cellulose, hydroxyethylcellulose and ethyl hydroxyethylcellulose; hydrophilic gums, such as gum arabic, gum karaya, gum tragacanth and gum ghatti, alginates; starch derivatives, such as carboxymethyl starch and phosphate starch; and combinations thereof.

Processes

In embodiments, a selective flocculation process comprises dispersing a ground bauxite ore in an aqueous medium to form a mixture, and adding one or more selective flocculants described herein to the mixture. In embodiments, the process further comprises adding one or more dispersants to the mixture. In embodiments, the process further comprises adding one or more surfactants to the mixture.

In embodiments, an effective amount of the one or more selective flocculants is added to the mixture. In embodiments, the one or more selective flocculants added to the mixture comprises one or more types of polysaccharides comprising one or more types of pentosan units.

In embodiments, an effective amount of the one or more dispersants is added to the mixture. In embodiments, the one or more dispersants added to the mixture are selected from the group consisting of polyacrylic acids, acrylic acid and acrylamide copolymers, polyphosphates, sodium silicates and the like.

In embodiments, an effective amount of the one or more surfactants is added to the mixture. In embodiments, the one or more surfactants added to the mixture comprises one or more anionic surfactants, such as fatty acids, rosin acids, sodium dodecyl sulfate, and the like.

In embodiments, the ground bauxite ore is contaminated clay minerals and/or siliceous gangue.

In embodiments, the process further comprises, after the one or more selective flocculants has been added to the mixture, vigorously mixing the mixture to ensure uniform distribution of the selective flocculants throughout the mixture. In embodiments, the process further comprises allowing the aluminum hydroxide and alumina, to settle from the mixture. For example, the aluminum-enriched particles may settle from the mixture as an underflow concentrate while the clay materials and siliceous gangue material remains suspended in the supernatant liquid.

As referred to herein, “settling” is the process by which particulates settle to the bottom of a liquid and form a sediment. Particles that experience a force, either due to gravity or due to centrifugal motion will tend to move in a uniform manner in the direction exerted by that force. For gravity settling, this means that the particles will tend to fall to the bottom of the vessel, forming a slurry at the vessel base. “Effective settling”, as used herein, refers to a desired amount of settling of aluminum hydroxide and alumina from the overflow to the underflow layers (i.e. feed or dispersed feed slurry), for example at least about 75%, about 80%, or about 85% of the aluminum hydroxide and alumina originally present in the feed have settled into the underflow concentrate. In certain embodiments, effective settling is accomplished within about 18 hours, about 12 hours, about 6 hours, about 3 hours, or within about 1 hour. In certain embodiments, effective settling is accomplished in the range of about 1 to about 24 hours, about 3 to about 24 hours, about 5 to about 24 hours, after the one or more selective flocculants have been added and mixed uniformly into the bauxite ore dispersion, however, the particular time of settling is not deemed critical and may vary widely depending upon the specific ore processed, the selective flocculant composition employed, the selective flocculant dosage applied and the like.

In embodiments, one or more thickeners are added to the mixture.

In embodiments, the process further comprises recovering the aluminum-enriched particles, for example, aluminum hydroxide and alumina. Such particles may be in the form of a concentrate, or contained in the underflow concentrate. The recovery step generally occurs after sufficient, or effective, settling of the mixture. This operation may be performed according to any conventional procedure while employing any conventional equipment associated with such procedures.

Generally, high grade bauxite ore may be directly fed to alumina manufacturing processes, such as the Bayer process. Lower grade bauxite resources may require processing either by particle size separation or flotation in order to prepare a material suitable for feeding such alumina manufacturing processes. The quality of bauxite ore feeding the alumina manufacturing, or Bayer, process may be measured by the “available alumina” and the “reactive silica”, or by the weight ratio of Al₂O₃ to SiO₂, which is, for example, greater than 10 for high grade alumina. In embodiments, if the grade of aluminum hydroxide and alumina in the underflow concentrate is sufficiently high, e.g. a Al₂O₃:SiO₂ of 10, then the underflow concentrate may be used without further flotation or other processes. If the grade of the aluminum hydroxide and alumina in the underflow concentrate is not at the desired level, a flotation step in which the remaining clay minerals and siliceous gangue are removed by froth flotation may be carried out.

In other embodiments, if the grade of the aluminum hydroxide and alumina in the underflow concentrate is not at the desired level, a Bayer process may be carried out to further enrich the aluminum hydroxide and alumina in the underflow concentrate. The Bayer process is a process for refining bauxite to produce alumina (aluminum oxide), which is well known in the art.

In embodiments, the process is a selective flocculation desliming process, which includes a hydrocyclone desliming process. In embodiments, the process is a selective flocculation desliming process, which does not include a hydrocyclone desliming process.

In embodiments, the selective flocculation process results in the selective flocculation of aluminum ores when compared to the flocculation of the clay materials and siliceous gangue so as to facilitate separation and recovery of aluminum hydroxide and alumina. Using the process, the flocculation of aluminum hydroxide and alumina may be performed such that aluminum grades of hydroxide and alumina, for example at least about 45%, or about 49% are obtained. In embodiments, the aluminum recovery of a process described herein is at least about 45%, or about 49%.

By “effective amount” of the selective flocculant is meant an amount of the selective flocculant that is effective in producing the desired degree of selective flocculation which, in turn, results in the desired degree of recovery of aluminum hydroxide and alumina. The particular amount that is effective will vary depending upon variables such as the particular bauxite ore processed, the specific composition of the one or more selective flocculants, the degree of dispersion, the particle size, and the like. In some embodiments, the effective amount will range from about 100 to about 1000 grams, or about 100 to about 300 grams, of selective flocculant per ton of bauxite ore processed.

In embodiments, a process for improving the grade of a bauxite ore concentrate, or the aluminum hydroxide and alumina in an ore sample, comprises selectively flocculating a mixture containing the ore comprising aluminum hydroxide and alumina and clay minerals and/siliceous gangue with one or more selective flocculants described herein to produce an enriched bauxite ore concentrate, or enriched aluminum hydroxide and alumina concentrate, and separating the concentrate from the clay minerals and siliceous gangue. In embodiments, the concentrate recovered from the processes described herein has an improved grade relative to the grade of the ore before the selective flocculation.

In embodiments, the one or more selective flocculants may be used prior to a desliming step, such as hydrocyclone desliming. In embodiments, the selective flocculants may be added to tailings streams of any of the processes described herein to enrich, or facilitate recovery of, aluminum hydroxide and alumina from the tailings stream. Generally, “tailings” refers to the materials left over after the process of separating the valuable fraction from the uneconomic fraction. In certain embodiments, the tailings stream comprises about 10 to about 50% aluminum-containing compounds. In embodiments, a process for enriching, or facilitating recovery of, aluminum hydroxide and alumina from a tailings stream comprising the aluminum hydroxide and alumina and clay minerals and/or siliceous gangue, wherein the process comprises carrying out a flocculation process in the presence of one or more selective flocculants described herein. In embodiments, the tailings stream is a tailings stream of a desliming process. In embodiments, the tailings stream is a tailings stream of a flotation process. In embodiments, the tailings stream comprises bauxite, aluminum hydroxide and/or alumina. In embodiments, the tailings stream comprises oxides of clay minerals, silica, silicates or siliceous materials. In embodiments, the process for enriching aluminum hydroxide and alumina from a tailings stream comprises the steps of:

(i) adding one or more selective flocculants according to the embodiments;

(ii) agitating the mixture to distribute the one or more selective flocculants;

(iii) allowing flocs to form; and

(iv) isolating the flocs.

In embodiments, the process comprises the steps of:

(i) mixing ground bauxite ore with a solvent to form a mixture;

(ii) adding one or more selective flocculants to the mixture;

(iii) agitating the mixture to distribute the flocculant;

(iv) adding one or more dispersants to the mixture;

(v) optionally adding one or more collecting agents and/or one or more surfactants to the mixture;

(vi) allowing flocs to form; and

(vii) isolating the flocs.

In embodiments, the one or more selective flocculants may be used to enrich bauxite ore concentrate, or to enrich aluminum hydroxide and alumina concentrate, in a tailings stream containing bauxite, aluminum hydroxide and/or alumina.

Other flocculants may be used in combination with the selective flocculants and are not particularly limited and include: starch such as starch derived from tapioca, corn, potato, wheat, rice and the like; starch activated by treatment with alkali; cellulose esters, such as carboxymethylcellulose and sulphomethylcellulose; cellulose ethers, such as methyl cellulose, hydroxyethylcellulose and ethyl hydroxyethylcellulose; hydrophilic gums, such as gum arabic, gum karaya, gum tragacanth and gum ghatti, alginates; starch derivatives, such as carboxymethyl starch and phosphate starch; and combinations thereof. In certain embodiments, the selective flocculants may be used in combination with selective flocculants comprising a polymer comprising: a) recurring units of one or more acrylamide monomers; b) recurring units of one or more monomers selected from hydroxyalkyl alkylacrylate, allyloxyalkyldiol, allyloxyethanol, trimethylolpropane allyl ether, and 2-hydroxy ethyl acrylate; and optionally, c) recurring units of one or more acrylic acid monomers.

According to various embodiments, the amount of selective flocculation may be quantified. For example, the amount of selective flocculation may be quantified according to the percent improvement of the bauxite ore or aluminum hydroxide and alumina grade, i.e., the change in percent by weight of the aluminum hydroxide and alumina in the concentrated material compared to the material before the froth flotation process. In embodiments, use of the selective flocculant causes the bauxite ore or aluminum hydroxide and alumina grade to increase by at least about 1%, about 1.5%, about 2%, about 2.5%, about 3%, about 4%, about 5%, about 6%, about 7%, about 8%, about 8%, or about 10%. Even relatively modest amounts of improvement to the recovered bauxite ore or aluminum hydroxide and alumina grade may represent significant increases in production and profitability of the method over time.

In embodiments, a process for enriching aluminum hydroxide and alumina from an ore having the aluminum hydroxide and alumina, and clay materials and/or siliceous gangue, includes carrying out a selective flocculation step prior to a flotation process in the presence of one or more dispersing agents.

In embodiments, the one or more dispersing agents are added at any stage of the process prior to the settling step. In certain embodiments, the one or more dispersing agents are added before or with the addition of the disclosed selective flocculating agents.

According to an embodiment, the selective flocculation process produces: a top fraction which is a clay minerals and siliceous gangue-enriched dispersion, for example, a silicate-enriched dispersion; and a bottom fraction which is rich in the aluminum hydroxide and alumina (underflow).

According to the embodiments, one or more steps may be performed prior to the selective flocculation step to prepare the bauxite ore for flocculation and flotation. For example, in one step of the process, the ore may be ground, together with water, to the desired particle size. The grain size of the ore and its degree of comingling with the silica groundmass determine the grind size to which the rock must be reduced to enable efficient separation, e.g., via subsequent desliming and froth flotation, to provide a high purity metal concentrate. In some embodiments, the average particle size of the ground ore is less than about 1 mm, e.g., between about 1 μm and 1 mm, about 1 and about 300 μm or between about 5 and 200 μm.

Optionally, conditioning agents such as sodium hydroxide and/or sodium silicate may be added to the grinding mill prior to grinding the crude ore. In an embodiment, sufficient water is added to the grinding mill to provide a slurry suitable for subsequent processing, as would be well understood in the art, for example, containing about 50% to about 70% solids, although this amount is understood to be not particularly limited.

In embodiments, a base or alkali pH adjuster may be added to adjust the pH of the slurry. For example, a pH adjuster may be added to the slurry to produce a pH in the range of about 6 to about 11, about 6 to about 10, about 6 to about 9, or about 7 to about 8. In embodiments, the pH of the slurry in the flocculation cell is maintained at between about 6 and about 11, or about 7 and about 8. In embodiments, the pH may be adjusted to produce optimum aluminum recoveries.

According to the embodiments, the selective flocculation process may include a step of adding one or more dispersing agents. For example, the dispersing agents may be added to the mixture before, after, or during the addition of the one or more selective flocculants and/or any other process agents.

In embodiments, the selective flocculation process may include a step involving conditioning or agitation of the mixture. For example, once all of the processing agents have been added to the mixture, the mixture may be further conditioned or agitated for a period of time before the settling step is carried out.

In embodiments, a process is provided for enriching aluminum hydroxide and alumina from bauxite ore comprising the aluminum hydroxide and alumina and clay materials and and/or siliceous gangue, wherein the process comprises carrying out a flocculation process in the presence of one or more selective flocculants. In certain embodiments, the flocculation process comprises the steps of:

(i) mixing ground bauxite ore with a solvent to form a mixture;

(ii) adding one or more selective flocculants to the mixture;

(iii) agitating the mixture to distribute the flocculant;

(iv) allowing flocs to form; and

(v) isolating the flocs.

In certain embodiments, the flocculation process comprises the steps of:
(i) mixing ground bauxite ore with a solvent to form a mixture;
(ii) adding one or more selective flocculants to the mixture;
(iii) agitating the mixture to distribute the flocculant;
(iv) adding one or more dispersants to the mixture;
(v) optionally adding one or more collecting agents and/or one or more surfactants to the mixture;
(vi) allowing flocs to form; and
(vii) isolating the flocs.

In certain embodiments, the step of isolating the flocs may comprise removing or separating most or all of the flocs from the mixture.

Nonionic and anionic surfactants and/or anionic collectors from 5 to 100 g/ton could improve the thickening sedimentation process i.e. sedimentation rate and decrease sedimentation time.

In embodiments, the selective flocculation process may be performed in a plurality of flocculation processing steps. For example, the selective flocculation process may be performed in flocculation units containing a plurality of communicating cells in series, with the first cell(s) being generally used for the rougher settling, and subsequent cell(s) being used for the more refined settling.

In embodiments, before selective flocculation treatment the ore-water slurry comprises about 2 to about 20%, about 2 to about 10%, or about 5 to about 8% by weight solids. In embodiments, the duration of the selective flocculation process depends upon the desired result. In embodiments, the time of selective flocculation treatment may be from about 1 to 10 minutes for each circuit. The time of the selective flocculation process may depend, at least in part, upon the clay minerals and siliceous gangue content, the grain size of the ore being treated and the number of flocculation cells involved.

In embodiments, the selective flocculants, compositions and processes may be used to provide higher selectivity and aluminum hydroxide and alumina recoveries, as compared to other flocculants, when used in flocculation processes. In embodiments, the selective flocculants, compositions and processes may be used to maximize the aluminum hydroxide and alumina recovery to increase production of metallic charge per unit ore fed, which in turn provides increases in production and profitability.

In embodiments, the selective flocculants, compositions and processes described herein may be used to improve the grade of available Al₂O₃. from bauxite ore such that the grade of the recovered available Al₂O₃ is at least about 45%, about 46%, about 47%, about 48%, or about 49%. In embodiments, the selective flocculants, compositions and processes described herein may be used to improve the grade of available Al₂O₃ from bauxite ore such that the grade of the recovered available Al₂O₃ is in the range of about 45% to about 50%.

In embodiments, the selective flocculants, compositions and processes described herein may be used to improve the grade of available Al₂O₃ from bauxite ore by at least about 20%, about 21%, about 22%, about 23%, about 24%, or about 25%. For example, the selective flocculants, compositions and processes described herein may be used to improve the grade of available Al₂O₃% from bauxite ore with an initial aluminum hydroxide and alumina grade of about 24% to a grade of at least about 49%.

In embodiments, the selective flocculants, compositions and processes described herein may be used to improve the recovery of aluminum hydroxide and alumina from bauxite ore to at least about 70%, about 75%, about 80%, about 85%, about 90%, or about 95%. In embodiments, the selective flocculants, compositions and processes described herein may be used to improve the recovery of aluminum hydroxide and alumina from bauxite ore such that the recovery of aluminum hydroxide and alumina is in the range of about 70% to about 99%, or about 75% to about 99%.

In embodiments, the flocculants, compositions and processes may be used to reduce the amount of clay minerals and/or siliceous gangue in a bauxite ore concentrate to less than about 20%, about 15%, or about 13%.

The following examples are presented for illustrative purposes only, and are not intended to be limiting.

### EXAMPLES

### Example 1

### Flocculation Test with Bauxite Ore and an Exemplary Selective Flocculant

In this example, flocculation tests were conducted and the objective of these tests were to separate the alumina from clay materials and siliceous gangue (SiO₂) in a bauxite ore sample. The exemplary selective flocculant, selective flocculant X, used in these experiments was a blend of polysaccharides present in plant cell walls comprising mainly xylan. Selective flocculant X may be prepared extracting corn fiber in DI water containing NaOH and H₂O₂ at about 60 to about 90° C. for 2-16 h. Solids were removed by centrifugation and the depressant X solution may be stored in a refrigerator until use.

Flocculation tests were done on a 2 L scale in a cylindrical vessel. A bauxite ore desliming overflow sample (from a Brazilian bauxite mine) with 7% solids was used in these experiments (pH 7-8). About 146 g of the bauxite ore slurry material were weighed and combined with 1945 g water. The exemplary selective flocculant, was then added in the desired amount (a dosage 500 g flocculant per ton of bauxite ore), and the contents of the tank were fully mixed for 1 minute. A polyacrylic acid dispersant (Mw of about 5000 to 6000 daltons) was added to the slurry in the desired amount (a dosage 160 g dispersant per ton of bauxite ore). Manual intensive mixing was used to blend chemicals and bauxite ore. The mixture was then allowed to settle for 18 hours and the top layer (overflow) was separated from the bottom (underflow) by a siphon device. The overflow (OF) and underflow (UF) layers were dried and measured by X-ray fluorescence. The results are provided in Table 1.

TABLE 1
Selective flocculation from desliming overflow
using selective flocculant X and a dispersant

| | Sample | | | | | | |
|---|---|---|---|---|---|---|---|
| | | | | Avail- | Reac- | | |
| | Total | | Total | able | tive | SiO₂ as | |
| | Al₂O₃ | Fe₂O₃ | SiO₂ | Al₂O₃ | SiO₂ | quartz | Clay |
| | (%) | (%) | (%) | (%) | (%) | (%) | (%) |
| Feed | 43.1 | 14.3 | 21.8 | 24.8 | 16.8 | 4.9 | 35.6 |
| material | | | | | | | |
| Underflow | 54.8 | 6.7 | 7.1 | 49.6 | 5.6 | 1.5 | 10.8 |
| material | | | | | | | |
| after | | | | | | | |
| treatment | | | | | | | |

Clay % = (Total Al₂O₃(%) − Available Al₂O₃(%)) + (Total SiO₂ (%) − Reactive SiO₂ (%))

Mass Recovery: 46.62% report to underflow.

Available Al₂O₃ Recovery: 93.24% report to underflow. It was observed that after a single stage of selective flocculation process with the exemplary selective flocculant and a dispersant, both reactive SiO₂ (−11.2%) and quartz (−3.4%) content decreased. The experiments also confirmed that the treatment with the exemplary selective flocculant produces an underflow product with significantly reduced clay content and greater aluminum grade which could be economically processed. Selective flocculant X was very effective for improving bauxite grade and removing clays.

In the preceding procedures, various steps have been described. It will, however, be evident that various modifications and changes may be made thereto, and additional procedures may be implemented, without departing from the broader scope of the procedures as set forth in the claims that follow.

1. A selective flocculant for beneficiation of bauxite ore, the selective flocculant comprising one or more types of polysaccharides comprising one or more types of pentosan units.

2. The selective flocculant of claim 1, wherein the one or more types of polysaccharides are derived from one or more types of lignocellulosic biomass.

3. The selective flocculant of claim 2, wherein the lignocellulosic biomass is selected from the group consisting of: herbaceous crops, wood and agricultural residues.

4. The selective flocculant of claim 3, wherein the herbaceous crop is grass.

5. The selective flocculant of claim 3, wherein the wood is hardwood.

6. The selective flocculant of claim 3, wherein the agricultural residue is selected from the group consisting of sugarcane bagasse, wheat straw, corn stover, corn fiber and mixtures thereof.

7. The selective flocculant of claim 1, wherein the one or more types of polysaccharides are derived from algae.

8. The selective flocculant of claim 1, wherein the one or more types of pentosan units comprise xylan units.

9. The selective flocculant of claim 1, wherein the one or more types of polysaccharides comprise one type of pentosan.

10. The selective flocculant of claim 9, wherein the one type of pentosan is xylan.

11. A composition comprising:
a selective flocculant according to claim 1; and
a solvent.

12. The composition of claim 11, wherein the solvent is water.

13. A process for enriching aluminum hydroxide and alumina from bauxite ore comprising the aluminum hydroxide and alumina and clay materials and and/or siliceous gangue, wherein the process comprises carrying out a flocculation process in the presence of one or more selective flocculants according to claim 1.

14. The process of claim 13, wherein the flocculation process comprises the steps of:
(i) mixing ground bauxite ore with a solvent to form a mixture;
(ii) adding one or more selective flocculants according to claim 1 to the mixture;
(iii) agitating the mixture to distribute the flocculant;
(iv) allowing flocs to form; and
(v) isolating the flocs.

15. The process of claim 13, wherein the flocculation process comprises the steps of:
(i) mixing ground bauxite ore with a solvent to form a mixture;
(ii) adding one or more selective flocculants according to claim 1 to the mixture;
(iii) agitating the mixture to distribute the flocculant;
(iv) adding one or more dispersants to the mixture;
(v) optionally adding one or more collecting agents and/or one or more surfactants to the mixture;
(vi) allowing flocs to form; and
(vii) isolating the flocs.

16. The process of claim 13, wherein the one or more selective flocculants is added in the form of a composition comprising the selective flocculant and a solvent.

17. The process of claim 16, wherein the solvent is water.

18. The process of claim 13, wherein the one or more selective flocculants are added to tailings streams.

19. The process of claim 18, wherein the tailings stream is a tailings stream of a desliming process.

20. The process of claim 18, wherein the tailings stream is a tailings stream of a flotation process.

21. The process of claim 18, wherein the tailings stream comprises aluminum hydroxide and alumina and/or bauxite ore.
